(19) United States
(12) Patent Application Publication
(10) Pub. No.: US 2017/0291648 A1
(43) Pub. Date: Oct. 12, 2017

(54) VIRTUAL SHAPING

(71) Applicant: Cool Flow Dynamics, Inc., Sarasota, FL (US)

(72) Inventors: Kahoru Watanabe, Sarasota, FL (US); Jignesh Soni, Sarasota, FL (US)

(21) Appl. No.: 15/473,094

(22) Filed: Mar. 29, 2017

Related U.S. Application Data
(60) Provisional application No. 62/320,116, filed on Apr. 8, 2016.

(51) Int. Cl. B62D 35/00

(52) U.S. Cl. CPC B62D 35/001

(57) ABSTRACT

Methods and apparatus for virtual shaping. A method includes positioning air flow shaping devices in a vehicle air gap to manipulate airflow to generate horizontal air vortices to reduce drag.

### CROSS REFERENCE TO RELATED APPLICATIONS

This application claims priority under 35 USC §119(e) to U.S. Provisional Application Ser. No. 62/320,116, filed on Apr. 8, 2016, and entitled VIRTUAL SHAPING, the entire contents of which are hereby incorporated by reference.

### BACKGROUND OF THE INVENTION

The present invention relates generally to drag, and more particularly to strategically creating air vortices and the efficiency benefits behind using them to produce the virtual shaping of air to seal “air” gaps.

In the United States, trucks account for over 60% of all commercial transport volume. This trend is unlikely to change in the foreseeable future. Class 8 trucks, the majority of which are commonly known as “semis” or “tractor trailers,” account for nearly 12% of all fuel consumed nationwide. The focus on increasing fuel efficiency by trucking companies, the Department of Energy (DOE) and Department of Transportation (DOT) is well warranted. A challenge is that a truck moving at 70 miles per hour (mph) consumes over 65% of its fuel simply to overcome friction resulting from contact and turbulence created in its wake (also referred as drag). A typical long haul truck will travel 150,000 miles a year at a rate of about 7 miles per gallon (mpg). This represents an average fuel cost per truck of $42,800 a year based on $2 per gallon. A significant reduction in drag would substantially reduce overall operational costs.

Another challenge comes from the trucking industry itself that has very stringent expectations based on its own operating experience experimenting with fuel efficiency solutions. The industry demands an easy to install solution that is low weight, low cost, rapid to install, inexpensive to repair or replace, easy to maintain, with minimal breakage risk from impacts, rapid payback and requires no driver interaction to operate the technology.

Systems are known for modulating airflow on trucks to improve efficiency. The company Aeroserve Corporation produces a device called an airtab™ that diverts air above the air gap. These solutions divert air flow from the vehicle surface. State of the art air flow solutions are being developed that use state of the art technologies such as synthetic jet actuators, linear plasma and serpentine actuators. They have shown to reduce drag, but are parasitic to the host truck with high power level requirements that are costly, while producing dangerous levels of ozone that are controlled by the Environmental Protection Agency (EPA).

The more common state of the art passive devices reduce drag simply by creating a physical barrier to the wind to reduce flow disruptions and thus turbulence and drag. These include truck side skirts, truck tractor hoods, gap extenders, boat tails and various other shapes and sizes that are added to trucks to reduce drag. These are the solutions most commonly seen on trucks around the world. The assignee of the present invention filed U.S. Provisional Patent Application No. 62/211,937 on 31 August 2015, titled “Device to generate active air flow control to generate drag reduction on vehicles.” This application related to using “fluke-like” structures to disrupt air flow. However, none of these solutions provide the combination of efficiency improvement, low cost, as well as ease of installation and maintenance as the present invention.

In addition to passively altering or diverting air flow away from vehicle surfaces, U.S. Pat. No. 3,971,586 discloses a V-shaped vertically oriented structure on the trailer of a truck. This structure was said to create a pair of stable vertical vortices in the cab/trailer gap and thereby reduce drag. Another vertical structure was shown in U.S. Pat. No. 7,318,620 directed toward stabilizing the cab/trailer vortex in cross wind conditions. However, neither of these solutions are optimized, and subsequent art does not provide an optimally efficient solution. In the case of U.S. Pat. No. 3,971,586, the inventor discusses using a “vacuum apparatus” to suck the stagnant air out of the vortices, which would result in the collapse of the same vertical vortices he was trying to create.

Existing state of the art vortex solutions create mini vortices similar to U.S. Pat. No. 7,318,620 to reduce the power of the air flow by either breaking up the laminar flows and weakening the drag, organizing the existing flow better by reducing turbulence or simply separating it into areas of high and low pressure. These may reduce drag minimally, but do not have the ability to close the cavity in the gap as the vortices of this invention can. The extremely low adoption rates by the trucking of these existing passive vortex solutions validate their low effectiveness.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to virtual shaping.

In one aspect, the invention features a method including positioning air flow shaping devices in a vehicle air gap to manipulate airflow to generate horizontal air vortices to reduce drag.

In another aspect, the invention features a system including a vehicle having a cab linked to a trailer, an air gap between the cab and the trailer, and air flow shaping devices, including at least one air flow device positioned horizontally in the air gap to manipulate airflow during a travel of the vehicle.

In still another aspect, the invention features a system including a train including a first train car linked to second train car, an air gap between the first train car and the second train car, and air flow shaping devices positioned in the air gap to manipulate airflow during a travel of the train.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is an exemplary diagram of a side view of a tractor truck.

FIG. 2A is an exemplary diagram of a side view of a tandem truck configuration.

FIG. 2B is an exemplary diagram of a side view of a train cargo box car configuration.

FIG. 3A is a perspective illustration of the side view of the gap.

FIG. 3B is a perspective illustration of the side view of the gap.

FIG. 3C is a perspective illustration of the top (above) view of the gap.

FIG. 4 are perspective illustrations of multiple air flow shaping devices.

FIG. 5A is an illustrative side view of an open vertical blade.

FIG. 5B is an illustrative side view of a CFD (Computational Fluid Dynamics) modeling.

FIG. 6A is an illustration of the side view of the gap.

FIG. 6B is an illustration of the side view of the gap.

FIG. 6C is an illustration of the side view of the gap.

FIG. 6D is an illustration of the side view of the gap.

FIG. 6E is an illustration of the top (above) view of the gap.

FIG. 7 is an illustrative side view of the front gap area.

FIG. 8A is an illustration of the front view of a state of the art common trailer.

FIG. 8B is an illustration of the front view of a state of the art common trailer.

FIG. 8C is an illustration of the front view of a state of the art common trailer.

FIG. 8D is an illustration of the front view of a state of the art common trailer.

FIG. 8E is an illustrative side view of a three vortex configuration on a short cab truck tractor.

FIG. 9A is an illustrative side view of a tandem trailer configuration.

FIG. 9B is an illustrative side view of train box cars.

FIG. 10A is an illustrative side view of a short cab truck.

FIG. 10B is an illustrative side view of the rear of a state of the art trailer.

FIG. 11A is an illustrative side view of the trailer.

FIG. 11B is an illustrative top view of the trailer.

FIG. 11C is an illustrative view of the rear of a trailer.

FIG. 12A is an illustrative side view of a tractor trailer.

FIG. 12B is an illustrative side view of a tractor trailer.

FIG. 12C is an illustrative side view of a tractor trailer with side curtains.

FIG. 13A is an illustration of the top (above) view of the gap between the tractor truck and the trailer.

FIG. 13B is an illustration of the top (above) view of the gap between the tractor truck and the trailer.

FIG. 13C is an illustration of the top (above) view of the gap between the tractor truck and the trailer.

FIG. 14 is an illustrative side view of a tandem trailer.

FIG. 15 is an illustration of the top (above) view of a tandem trailer.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

In the description below, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

The present invention creates air vortices using passive air flow devices that produce virtual shaping that reduces drag in transport vehicles.

This is accomplished by using physical air flow shaping devices strategically positioned to manipulate airflow to generate air horizontal vortices which then reduce drag for a variety of vehicles, including but not limited to large, commercial vehicles.

The scientific principals laid out in this invention are derived from our actual laboratory testing as we have been able to create vortices in the gap area that have shown dramatic improvements in drag reduction performance. State of the art truck hoods and gap extenders combined produce a maximum of 7% drag reduction, in contrast, using vortices, we have been able to improve on that number on various truck designs by 100% to 200%. This is far from an incremental improvement in performance and validate the science behind this concept and invention.

In one general aspect, the present invention is a plurality of self-contained, aerodynamically shaped air flow shaping devices. The purpose of these devices is to act in conjunction with each other and the naturally occurring air flows around it to produce powerful horizontal and in some iterations vertical air vortices that become self -contained and seal open gaps and thus reduce drag. It is known that a sleek surface with no gaps reduces drag. What is less known, however, is that though a sleek surface has less drag, such a surface still presents greater drag than air transitioning over a “surface” of pressurized air due to friction.

The present invention manipulates airflow to generate horizontal and in some iterations vertical air vortices in contained environments so that they naturally conform to the existing shape to seal the gap areas of vehicles. This process is called virtual shaping. By filling the gaps with circulating air, drag is reduced in the open cavity, while air on air interaction does not produce friction. Wind tunnel results have shown reductions in drag of up to 16.7% at 60 miles per hour and up to 39% at 30 miles per hour. This is significant as a vehicle expends more fuel as it accelerates from 0-40 mph and stabilizes as it reaches highway speeds. Drag is also more concentrated on the forward half of the truck tractor and trailer as it accelerates at the lower speeds. The significance of the higher efficiency at lower speeds cannot be understated when assessing the short haul carriers that spend more time in urban and suburban areas where they will spend more time at lower average speeds.

The present invention manipulates naturally occurring air flow to generate air vortices that match the air flow speed around it. Note that this system is passive—meaning existing airflow is used to generate vortices. This is in contrast to active solutions that may try to generate airflow actively. However, for example, a 90 kilometer per hour vortex would be very difficult to reproduce in an active system using any technology without expending high amounts of power which would then be deducted from any energy gains.

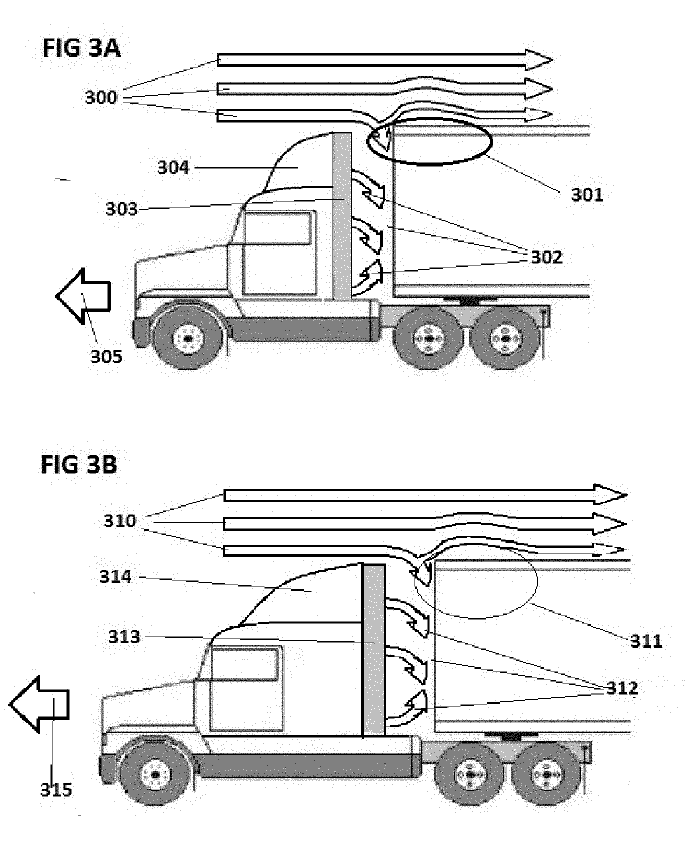

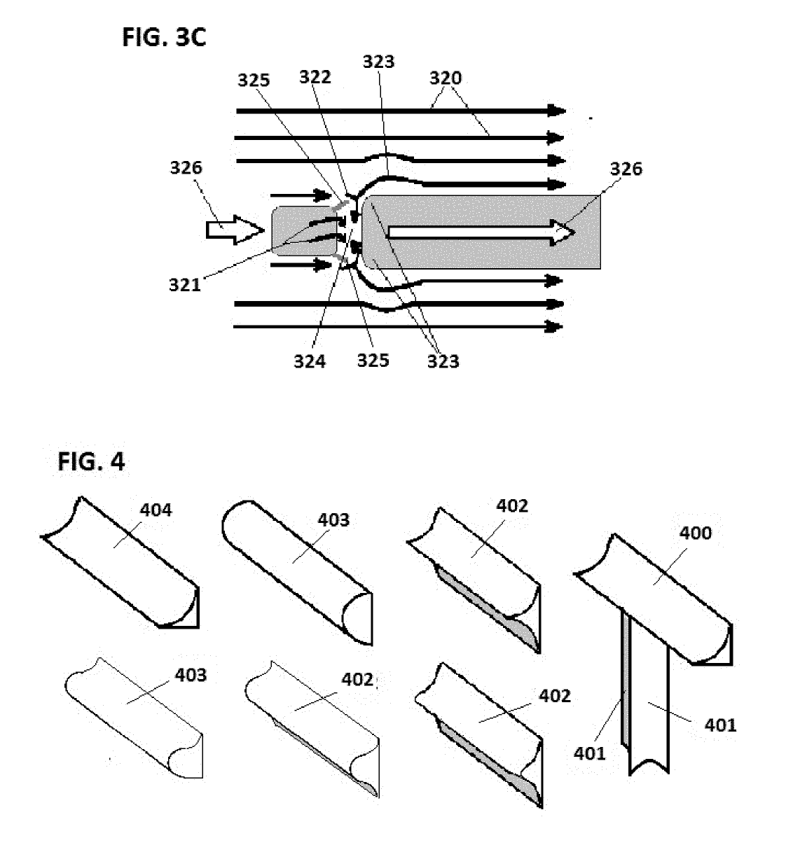

In wind tunnel testing we have determined that two fundamental configurations produce the best drag and similar reduction results. Most importantly, U.S. Pat. No. 3,971,586 discusses one vertically oriented concave ‘drag reducing member’ attached to the trailer side and one “mounted on the opposite walls substantially in the same plane.” It also speaks of a “Vortex 30 having a substantially horizontal axis tries to form in an attempt to complete the horseshoe shaped vortex 32, depicted in FIG. 3, that would form and be stable in an ideal situation. Vortex 30 however is not stable in the configuration shown because the head-on air flow coming over the roof 15 of tractor 12 will interfere with the vortex formation and stability.”

The critical differentiator of this invention is that the primary objective (unlike U.S. Pat. No. 3,971,586 where the intent was vertical vortices) and results is that it stabilizes the horizontal vortex by re-directing and manipulating the air flow coming over the roof. This upper horizontal vortex can then be re-directed in the cavity of the gap to then generate a secondary lower horizontal vortex. The two combined horizontal vortices then seal the entire area of the gap through virtual shaping. In order to accomplish this, two or three ‘drag reducing members’ (From this point referred to as “air flow shaping devices” for the purposes of this patent) as they are referred to in U.S. Pat. No. 3,971,586 are required on the leading front of the trailer and for an extended truck tractor (Known as “sleepers”) one horizontal air flow shaping device positioned near the center of and slightly below the parallel plane of the trailer side middle air flow shaping devices for optimal rotation. In the case of a short cab truck with a roof fairing, in order to produce this two horizontal vortex configuration, two or three air flow shaping devices are placed similarly to that of an extended cab truck on the trailer side, and on the truck tractor side, one parallel air flow shaping device may be attached if necessary.

In wind tunnel tests vertical vortices were created for this invention application. Unlike U.S. Pat. No. 3,971,586, in order to generate two effective vertical vortices in the gap, it was necessary to isolate their rotation from the horizontal vortex on the upper portion of the gap. By isolating and separating the three rotations, it was possible to generate three stable vortices throughout the operating speeds of the truck trailer. This required the development of a “T-Shaped” air flow shaping device. The upper part parallel part of the “T” shape was to help form and contain the upper gap horizontal vortex and keep it separate from the two vertical vortices forming below it. The perpendicular part of the “T” shape was to separate the two lower vertical vortices from each other. This configuration also creates virtual shaping as the three individual vortices are rotating in junction with the speed of the surrounding air flow with which it makes contact and sustains both its speed and its shape. This configuration does not work unless the horizontal vortex that seals the upper part of the gap is stable and the T-Shape is positioned and shaped so that the 3 vortices are kept separate.

Another key advantage of this invention is that it is more effective when Gap extenders, roof fairings and extended cab trucks that have built in roof fairings are present.

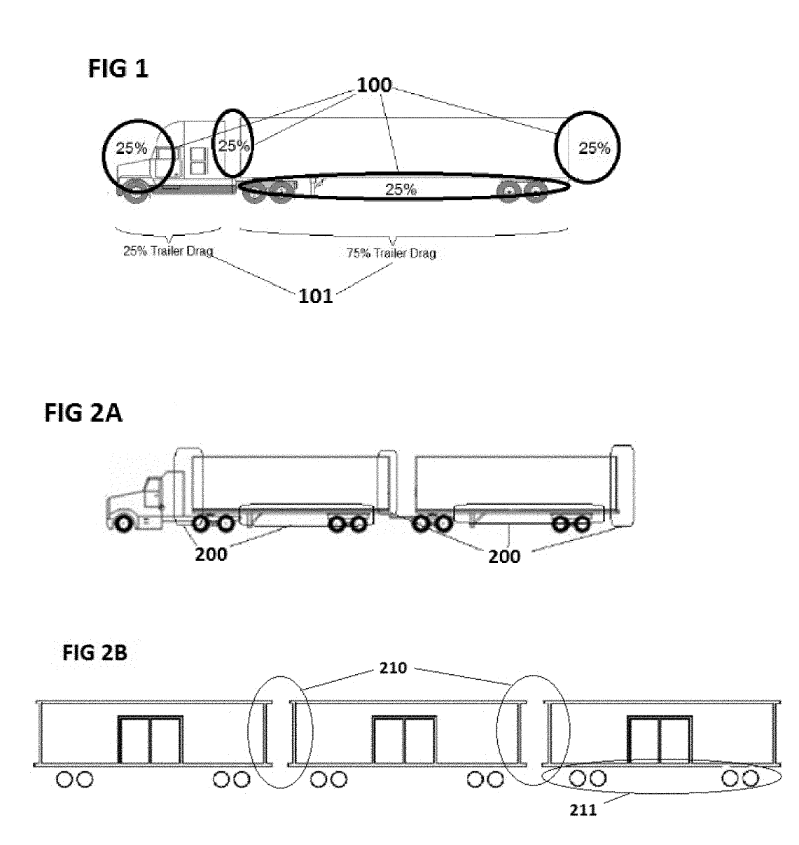

FIG. 1 is an exemplary diagram of a side view of a tractor truck and trailer illustrating the areas 100 impacted by drag and the percentage 101 of the overall drag by key areas.

FIG. 2A is an exemplary diagram of a side view of a tandem truck configuration showing an illustration of certain areas 200 which can be addressed using the present invention.

FIG. 2B is an exemplary diagram of a side view of a train cargo box car configuration showing an illustration of certain areas 210 which can be addressed using the present invention.

FIG. 3A is a perspective illustration of the side view of the gap between a short cab tractor truck 303 and the trailer 301 showing the directional movement of air flow 300/302 as it flows across the upper surface area of the gap in its as-is state, prior to the invention of this description being put into place. A scoop 304 is placed on the cab 303 and the truck is moving in a forward direction 305.

FIG. 3B is a perspective illustration of the side view of the gap between an extended cab tractor truck 313 and the trailer 311 showing the directional movement of air flow 310 as it flows across the upper area of the gap prior to the invention of this description being put into place. A scoop 314 is placed on the cab 313 and the truck is moving in a forward direction 315.

FIG. 3C is a perspective illustration of the top (above) view of the gap between the tractor truck and the trailer showing the directional movement of air flow as it flows across the sides and top of the gap prior to the invention of this description being put into place. Here, as the truck moves forward, air 326 strikes the ab and flows over the trailer. Some air 329 flows uninterrupted over the cab/trailer. Some air 321, 322, 323, 324 flows in and about the gap even with wind deflectors 325.

FIG. 4 are illustrations of multiple air flow shaping devices 400, 401, 402, 403, 404 of this invention and their geometries used to passively generate air vortices in this invention. Each include a geometry that provides a unique contour. The devices 400, 401, 402, 403, 404 shown may be constructed of wood, plastic, metal, composite, rubber or combinations thereof, and exhibit different shapes and sizes.

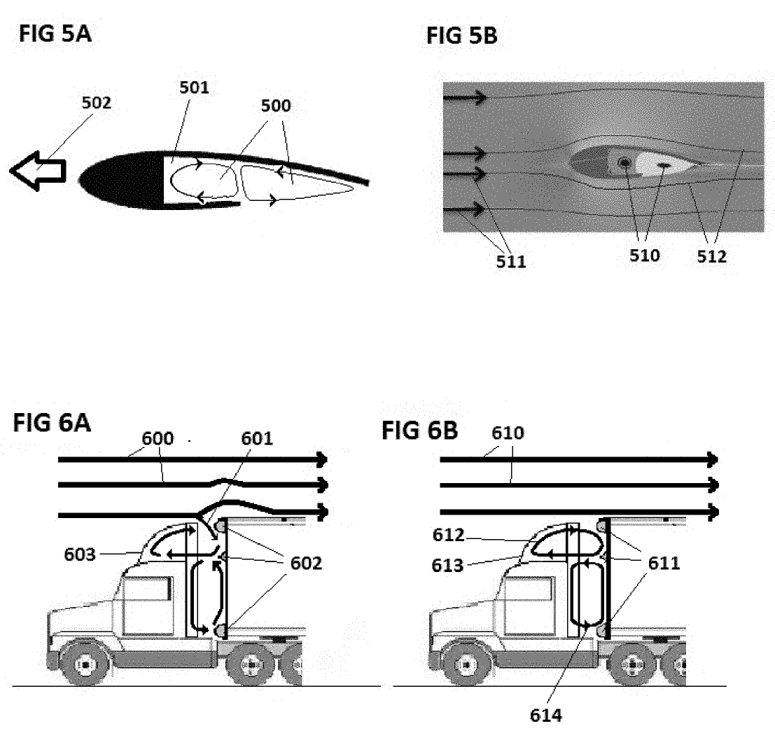

FIG. 5A is an illustrative side view of an open vertical blade used in wind turbines illustrating the two counter rotating vortices 500 formed in the open cavity 501 as the blade moves in a forward direction 502, which is similar to those described in this invention.

FIG. 5B is an illustrative side view of a CFD (Computational Fluid Dynamics) modeling which shows the two rotating vortices within the open cavity, and the concept of virtual shaping as described in this invention.

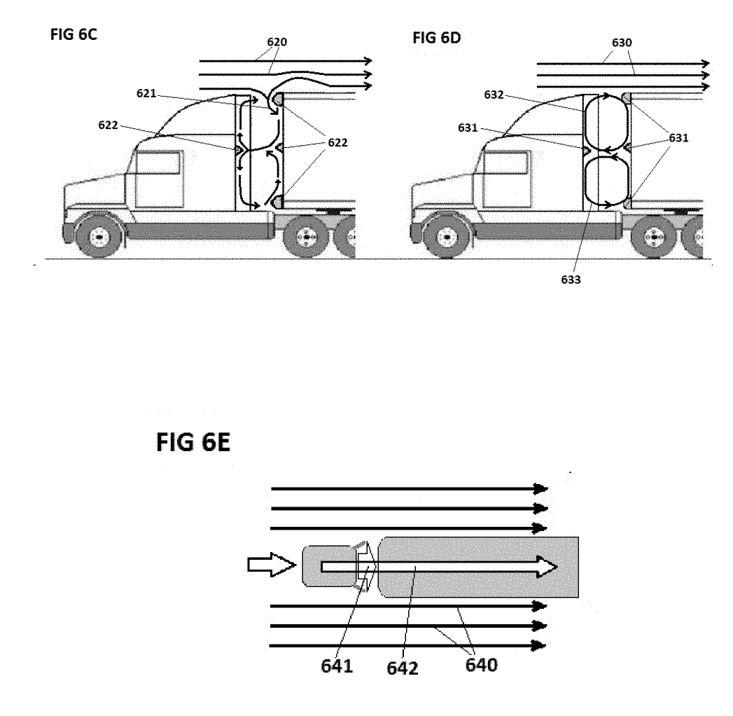

FIG. 6A is an illustration of the side view of the gap between a short cab tractor truck and the trailer showing the directional movement of air flow 600, 601, 603 as the vehicle begins to accelerate. The air flow across the upper area of the gap begin creating vortices as a result of the shown placement of air flow shaping devices 602 or this invention which result in sealing the gap and virtual shaping of the air flow.

FIG. 6B is an illustration of the side view of the gap between a short cab tractor truck and the trailer showing the directional movement of air flow 610, 612, 613, 614 as it becomes a stable flow across the upper area of the gap as a result of the shown placement of air flow shaping devices 611 for this invention as the gap is sealed by the virtual shaping of the air flow created by the vortices.

FIG. 6C is an illustration of the side view of the gap between an extended cab tractor truck and the trailer showing the directional movement of air flow 620, 621, as it flows across the upper area of the gap and begins creating vortices as a result of the shown placement of air flow shaping devices 622 for this invention which result in sealing the gap by virtual shaping the air flow.

FIG. 6D is an illustration of the side view of the gap between an extended cab tractor truck and the trailer showing the directional movement of air flow 630, 632, 633 as it becomes a stable flow across the upper area of the gap as a result of the shown placement of the air flow shaping devices 631 for this invention as the gap is sealed by the virtual shaping of the air flow created by the vortices.

FIG. 6E is an illustration of the top (above) view of the gap between the tractor truck and the trailer showing the directional movement of air flow 640, 642 as it flows across the sides and top of the gap, and the resulting vortices 641 created by the air flow shaping devices of this invention as the gap is sealed by the virtual shaping of the air flow created by the vortices.

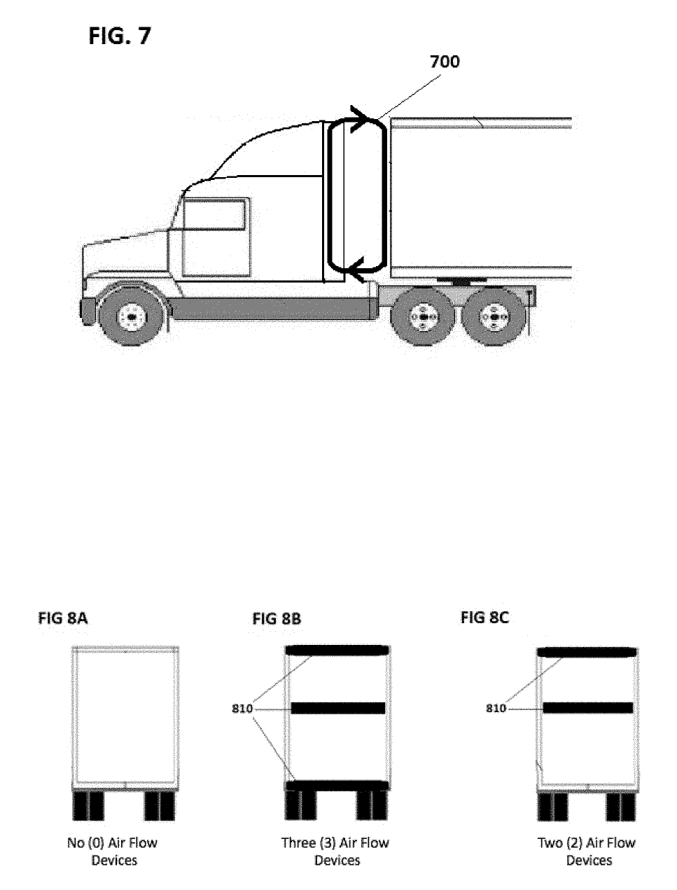

FIG. 7 is an illustrative side view of the front gap area of an extended cab truck with a single vortex 700 configuration of this invention being generated.

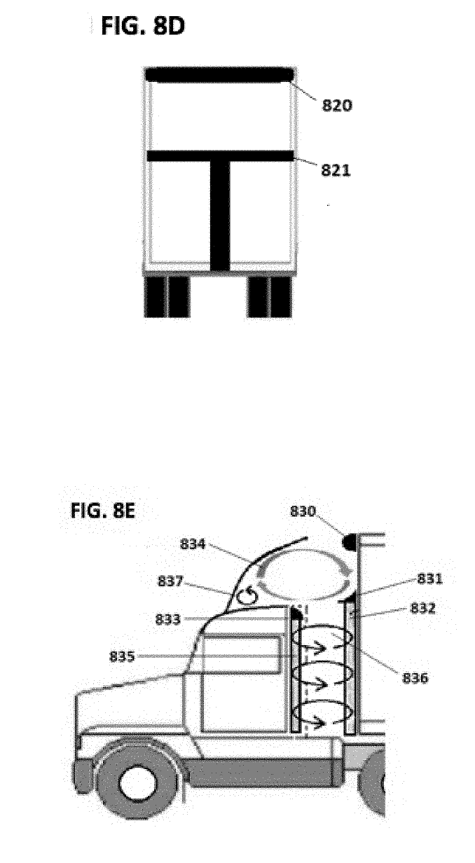

FIG. 8A is an illustration of the front view of a state of the art common trailer in its as is state.

FIG. 8B is an illustration of the front view of a state of the art common trailer illustrating relative locations of three air flow shaping devices 810 of FIG. 4 positioned for a two vortex configuration of this invention.

FIG. 8C is an illustration of the front view of a state of the art common trailer illustrating relative locations of two air flow shaping devices 810 of FIG. 4 positioned for a two vortex configuration of this invention.

FIG. 8D is an illustration of the front view of a state of the art common trailer illustrating relative locations of the air flow shaping devices 820, 821 of FIG. 4 positioned for a three vortex configuration of this invention.

FIG. 8E is an illustrative side view of a three vortex configuration 836 on a short cab truck tractor showing the position of the air flow shaping devices 830, 831, 833 of this invention and the resulting vortices.

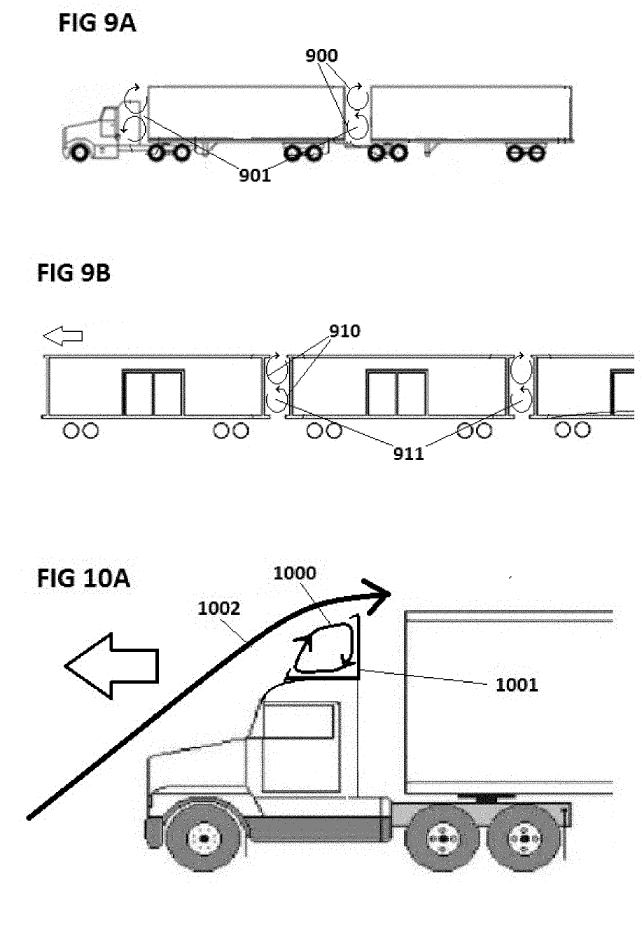

FIG. 9A is an illustrative side view of a tandem trailer configuration with double vortex configurations 900, 901 of this invention illustrated between the gaps.

FIG. 9B is an illustrative side view of train box cars with double vortex configurations 910, 911 of this invention illustrated between the gaps.

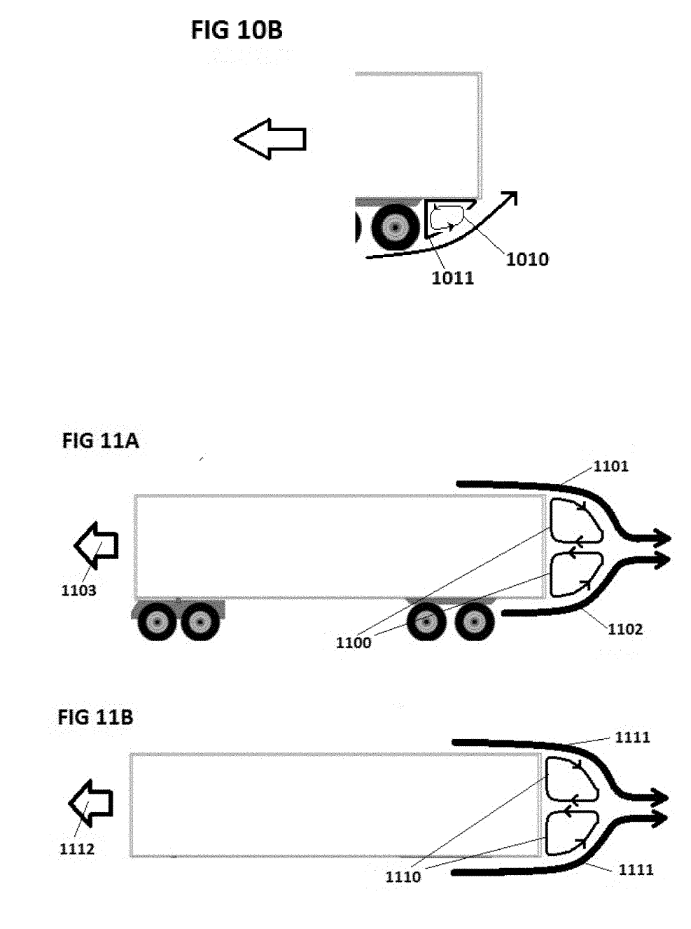

FIG. 10A is an illustrative side view of a short cab truck with a vortex 1000 of this invention being generated in a roof fairing configuration 1001.

FIG. 10B is an illustrative side view of the rear of a state of the art trailer with a vortex 1010 of this invention being generated behind the rear wheels and back end 1011 of the trailer.

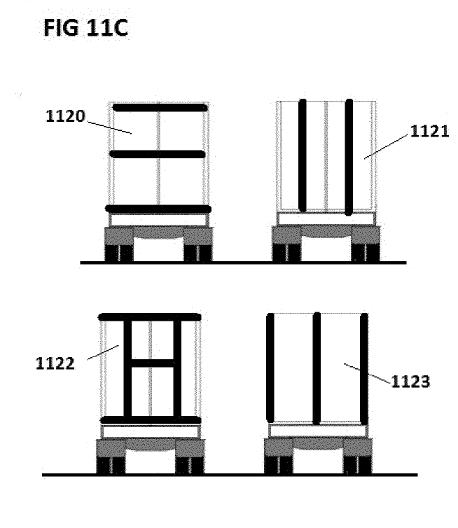

FIG. 11A is an illustrative side view of the trailer showing two vortices 1100 being generated in a horizontal configuration by this invention to create virtual shaping, around which the air flow is illustrated moving across the top part 1101 and the lower part 1103 with the trailer moving in a direction 1103.

FIG. 11B is an illustrative top view of the trailer showing two vortices 1110 being generated in a vertical configuration by this invention to create virtual shaping, around which the air flow is illustrated moving across the sides 1111 moving in a direction 1112.

FIG. 11C is an illustrative view of the rear of a trailer showing multiple positions 1120, 1121, 1122, 1123 of the air flow shaping devices of FIG. 4 to create vertical and horizontal vortices of this invention.

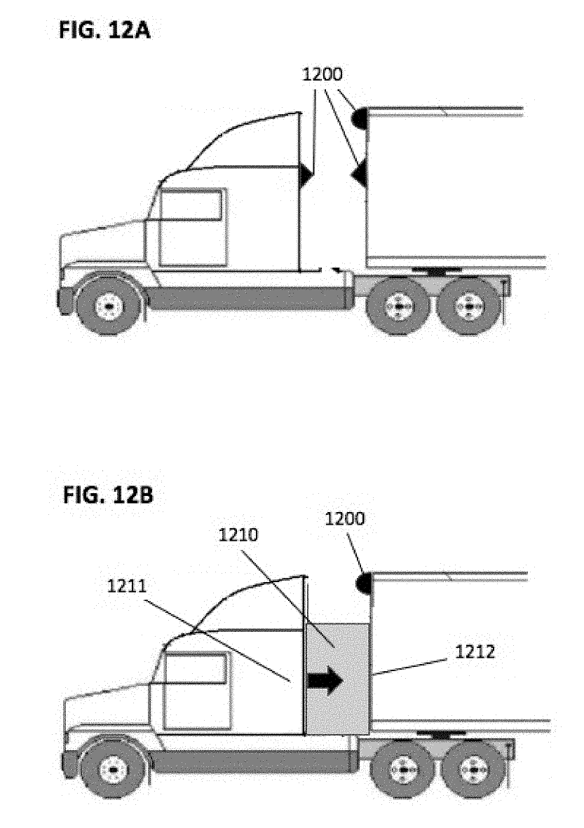

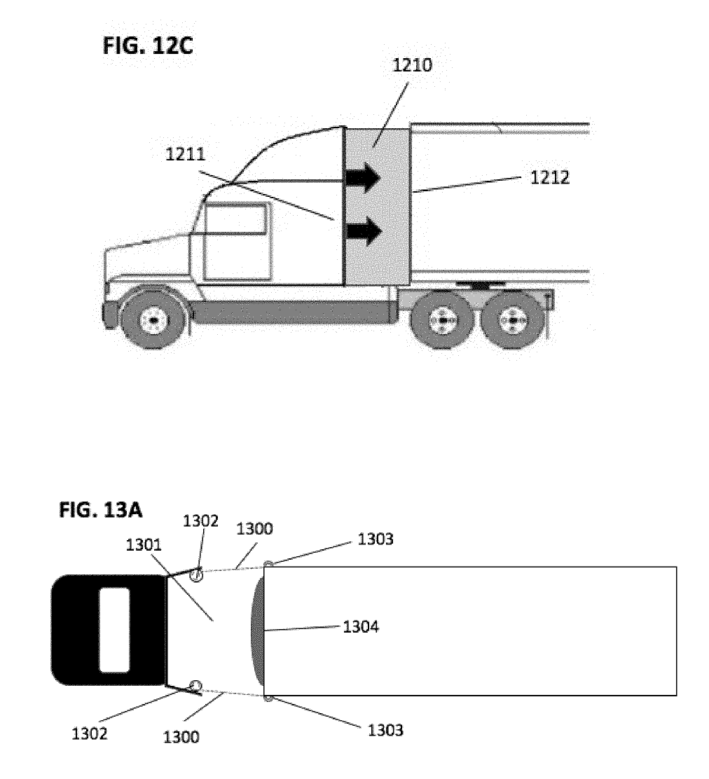

FIG. 12A is an illustrative side view of a Tractor trailer in its as-is state with the gap between the truck and trailer open and exposed with devices of this invention installed 1200.

FIG. 12B is an illustrative side view of a Tractor Trailer with side curtains 1210 attached, which are attached to the area behind the gap extenders 1211 and stretch across the gap is attached to the trailer side 1212, in this iteration sealing the sides of the gap leaving the upper portion of the gap exposed to produce a horizontal vortex, being managed by the devices 1200 of this invention. All devices are not visible in this illustration.

FIG. 12C is an illustrative side view of a Tractor Trailer with side curtains 1210 attached, which are attached to the area behind the gap extenders 1211 and in this iteration extend to or nearer to the top of the gap extenders. In this iteration, the side curtain will still stretch across the gap and attached to the trailer side 1212. Although the devices of this invention are not visible in this illustration, they may or may not be installed for this iteration, to improve circulation.

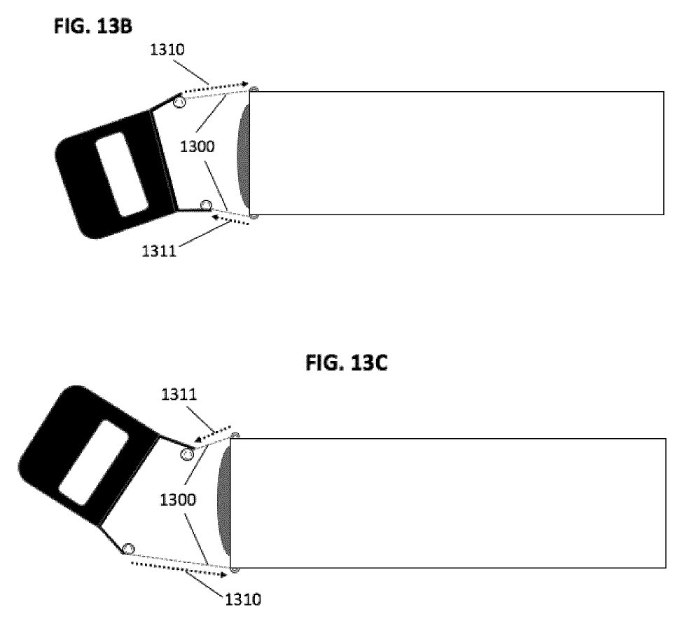

FIG. 13A is an illustration of the top (above) view of the gap between the tractor truck and the trailer showing the side curtains 1300 enclosing both sides of the gap 1301. The housing device 1302 for the side curtains allow the curtain to roll in and out, in similar fashion to an automotive seatbelt or roller blind mechanism for windows. The leading edge of the curtain would be outfitted with a clamping mechanism to allow it to be secured to a matching securing mechanism 1303 on the trailer side. A device of this invention 1304 may or may not be used in this iteration.

FIG. 13B is an illustration of the top (above) view of the gap between the tractor truck and the trailer showing the side curtains 1300 adjusting in length during a left turn. Due to the automatic contraction and extension of the curtain resulting from its mechanism, one side extends 1310, while the other contracts 1311.

FIG. 13C is an illustration of the top (above) view of the gap between the tractor truck and the trailer showing the side curtains 1300 adjusting in length during a right turn. Due to the automatic contraction and extension of the curtain, resulting from its mechanism, one side extends 1310, while the other contracts 1311.

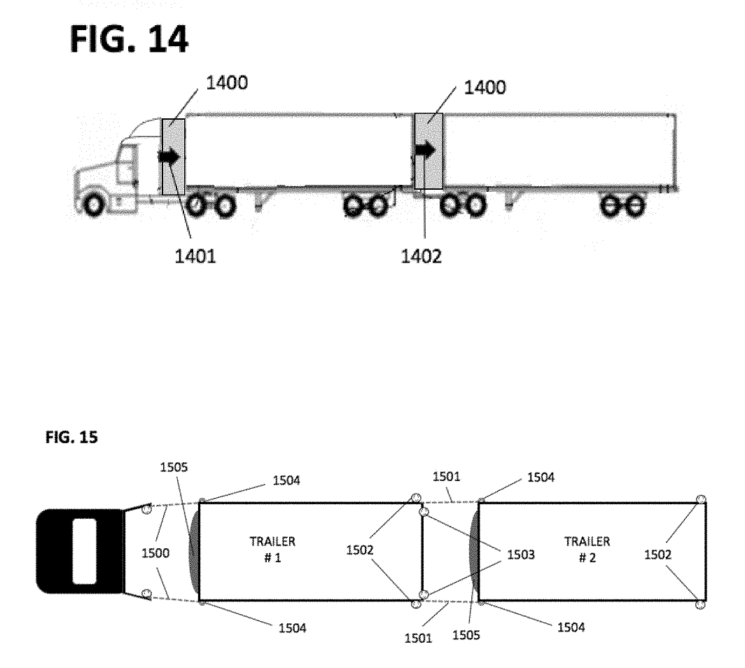

FIG. 14 is an illustrative side view of a tandem trailer configuration with side curtain 1400 attached to cover the gaps between the truck tractor and trailer 1401. For Tandem trailers, an additional housing 1402 containing a side curtain would be mounted to cover the gap between the 2 trailers.

FIG. 15 is an illustration of the top (above) view of a tandem trailer configuration with side curtain 1500 attached to cover the gaps between the truck tractor and trailer and between the 2 trailers 1501. An additional curtain housing unit could be attached to the outside surface of the rear of the trailer 1502 or alternatively on the inside part of the trailer door 1503. The connecting latches 1504 for the curtains on the trailer would be “universal” to match the curtain configuration. The devices of this invention 1505 may or may not be present on any trailers with the curtains attached.

Various embodiments of this invention may be created by altering the shape, dimensions, placement, the angle of the flow, concentration of the air flow being generated and even the pattern of airflow release. This invention may be used in other applications including trains, ships, cars or any vehicle that moves and experiences drag that is created by air flow.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
positioning a plurality of air flow shaping devices in a vehicle air gap to manipulate airflow to generate horizontal air vortices to reduce drag.

2. The method of claim 1 wherein the air gap is a void located between an operator cab and a trailer body.

3. The method of claim 1 wherein the air gap is a void located between two vehicles linked together.

4. The method of claim 1 further comprising a vertically oriented air flow shaping device, wherein the plurality of air flow shaping devices act in conjunction with each other and the naturally occurring air flows around it to produce horizontal and vertical air vortices that become self-contained and seal open gaps to reduce drag.

5. The method of claim 4 wherein each of the plurality of air flow shaping devices is manufactured from the group consisting of wood, plastics, metals, composites, and rubber.

6. A system comprising:
a vehicle having a cab linked to a trailer;
an air gap between the cab and the trailer; and
a plurality of air flow shaping devices, including at least one air flow device positioned horizontally, in the air gap to manipulate airflow during a travel of the vehicle.

7. A system comprising:
a train comprising a first train car linked to second train car;
an air gap between the first train car and the second train car; and
a plurality of air flow shaping devices positioned in the air gap to manipulate airflow during a travel of the train.
